(19) United States
(12) Patent Application Publication
(10) Pub. No.: US 2006/0131896 A1
(43) Pub. Date: Jun. 22, 2006

(54) Cargo container door lock with theft prevention means

(75) Inventor: Kum-Sik Jeong, Busanjin-gu Busan (KR)

Correspondence Address: BIRCH STEWART KOLASCH & BIRCH, PO BOX 747, FALLS CHURCH, VA, 22040-0747, US

(73) Assignee: S.J. KOREA CO., LTD., Gimhae-Si (KR)

(21) Appl. No.: 10/522,878

(22) PCT Filed: Jul. 25, 2003
(86) PCT No.: PCT/KR03/01503

§ 371 Date: Sep. 26, 2005

(30) Foreign Application Priority Data
Aug. 9, 2002 (KR) 10 20020047088

(51) Int. Cl. E05B 3/00

(52) U.S. Cl. 292/336.3

(57) ABSTRACT

Disclosed herein is a cargo container door lock, which prevents a theft of goods in a cargo container, and enables prompt identification tampering has occurred. The door lock comprises a handle hub (300) welded to one side of a locking rod (200), and a handle (400) coupled with the handle hub (300) using a rivet (500). The handle hub is formed with fastening holes (320), and circular recesses (330) formed at opposite outer sides of the fastening holes (320), respectively, and having a diameter larger than that of the fastening holes (320). The rivet (500) is fastened through the fastening holes (320) so that a head (510) thereof is fitted inside one of the circular recesses (330), and an expanded piece (520) thereof is fitted inside the other one of the circular recesses (330). The handle (400) is formed at its center portion with a stopper (430), which is caught by a holding piece (610) of a fixing plate (600), thereby restricting the movement of the handle (400).

### TECHNICAL FIELD

The present invention relates to a cargo container door lock, and more particularly to a cargo container door lock, which is configured to reinforce its theft prevention function, and clearly indicate tampering has occurred during transit, thereby enabling prompt action to be taken based on evidence of tampering.

### BACKGROUND ART

Generally, Large, cargo containers are the most commonly used means of transporting large volumes of many varying cargos from location to location around the world. Especially, in case that large quantities of goods are exported to or imported from abroad, the goods first are loaded into cargo containers and then transported on ships.

The cargo containers usually are left at wharves for a long time period during shipping. Even after they are shipped, it often takes them a long time to arrive at their eventual destination. During such custody and transit, the contents of the cargo containers are often robbed due to structural defects of door locks installed thereto. Moreover, such door locks for cargo containers do not provide substantially clear and noticeable evidence of tampering even if a robbery has occurred.

The above problems are caused by the poor structure of currently used cargo container door locks as follows.

Referring to FIG. 9 illustrating a door lock of the prior art, the door lock comprises a handle hub 20 welded to one side of a locking rod 10. The handle hub 20 has a pair of support pieces 21 and 22 located at both sides thereof. The support pieces 21 and 22 are drilled with fastening holes 23, respectively, which are formed to coincide with each other.

The handle hub 20 further has an insertion portion 24 defined between the support pieces 21 and 22. The insertion portion 24 is configured to allow a handle 30 to be inserted therethrough. The handle 30 is formed with a connection portion 31 at one side thereof as shown in FIG. 11, and the connection portion 31 is drilled with a fastening hole 32. Considering the insertion of the handle 30 into the handle hub 20, first, the connection portion 31 of the handle 30 is inserted through the insertion portion 24 of the handle hub 20 so that the fastening hole 32 of the connection portion 31 coincides with the fastening holes 23 of the support pieces 21 and 22. Then, a rivet 40 is fitted through the fastening holes 23 and 32. The rivet 40 is provided at one side thereof with a rivet head 41 having a diameter larger than the diameter of the fastening holes 23 and 32. The rivet 40 is fastened through the fastening holes 23 and 32 until the rivet head 41 is caught by the support piece 21. In this state, an opposite end portion of the rivet 40 is protruded from the fastening hole 23 of the other support piece 22. The protruded end portion of the rivet 40 is compressed by receiving a certain force to form an expanded piece 42 for preventing the withdrawal of the rivet 40. In this way, the handle 30 is rotatably coupled in the handle hub 20 welded to the locking rod 10.

The handle 30 is also coupled to a fixing plate 60 attached to an outdoor-side surface of a cargo container door 50. The fixing plate 60 is provided at the lower side thereof with a holding piece 61 protruding outwardly, and at the upper side thereof with a movable catch piece 62.

In order to open the cargo container door 50, first, the catch piece 62 is rotated upwardly in a clockwise or counterclockwise direction to be released from the handle 30, and then the handle 30 is slightly and upwardly rotated so that the body of the handle 30 is released from the holding piece 61. In this state, as the handle 30 is pulled toward the front side thereof, the locking rod 10 is rotated, thereby causing locking means, namely, lockers provided at upper and lower ends of the locking rod 10 to be released, resulting in opening of the container door 50.

Where a cargo container having the door lock as stated above is transported while loading goods, the handle 30 coupled with the handle hub 20 is retained between the holding piece 61 and the catch piece 62 mounted at the fixing plate 60, and then fastened together with a strap. Additionally, the strap is sealed so that the cargo container door 50 cannot be opened without removing a seal.

In case of the conventional door lock as stated above, however, since the rivet 40 fastening the handle 30 with the handle hub 20 is fitted through the handle 30 and handle hub 20 in a manner as shown in FIG. 10, and the expanded piece 42 of the rivet 40 is completely exposed outwardly, a thief can simply steal the contents of the cargo container without cutting the fastening strap sealing the handle 30.

That is, where the thief cuts the expanded piece 42 forwardly protruded from the handle hub 20 using a grinder, the rivet 40 is simply separated from the handle hub 20, and also the handle 30 is completely separated from the handle hub 20 by simply pushing the handle 30 in an opposite direction to the handle hub 20 as shown in FIG. 13. In a state wherein the interference of the handle 30 is eliminated as stated above, the locking rod 10 is adapted to freely rotate as the handle hub 20 is pulled forward. In this way, the thief can easily rob the contents of the cargo container by simply opening the cargo container door 50 without cutting the fastening strap sealing the handle 30.

Even when a theft is complete, the thief can perfectly mask the evidence of tampering by again inserting the handle 30 into the handle hub 20 and fitting the rivet 40 through the fastening holes 23 and 32. As a result, the conventional door lock has a problem in that the identifying seal has never been removed and thus no evidence of tampering is available.

### DISCLOSURE OF THE INVENTION

Therefore, the present invention has been made in view of the above problems, and it is an object of the present invention to provide a cargo container door lock configured in such a fashion that it is substantially difficult to unnoticeably cut an expanded piece of a rivet fastening a handle and a handle hub of the door lock.

It is another object of the present invention to provide a cargo container door lock configured in such a fashion that, even if an expanded piece of a rivet is forcibly cut to separate a handle from a handle hub, holding means separately formed at the handle controls the movement of the handle under the influence of a holding piece and a catch piece provided at a fixing plate associated with the handle so as to cause the handle to be positioned inside the handle hub without being completely separated from the handle hub, thereby preventing the rotation of a locking rod provided at a cargo container door.

It is yet another object of the present invention to provide a cargo container door lock, which prevents the opening of a cargo container door unless a fastening strap sealing a handle is completely cut and a handle is rotated, thereby protecting the contents of a cargo container and providing substantially clear and noticeable evidence of tampering in case of cutting the fastening strap sealing the handle.

In accordance with one aspect of the present invention, the above and other objects can be accomplished by the provision of a cargo container door lock comprising: a handle hub, the handle hub having a pair of fastening holes and a pair of circular recesses formed at opposite outer sides of the fastening holes, respectively, and having a diameter larger than that of the fastening holes; and a rivet to be fastened through the fastening holes of the handle hub so that parts of a rivet head and compressed expanded piece thereof are seated in the circular recesses, respectively, thereby preventing them from being cut and removed even if they are forcibly cut using cutting tools, resulting in a complete prevention of separation between the rivet and handle hub.

In accordance with another aspect of the present invention, there is provided a cargo container door lock comprising a handle formed with a separate stopper protruded from a center portion thereof so as to come into contact with a holding piece protruded from a fixing plate associated with the handle, thereby preventing the handle from moving away from a handle hub even if a rivet used to fasten the handle with the handle hub is released, and consequently preventing a connection portion formed at one side of the handle from being separated from the handle hub.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view illustrating the configuration of a door lock in accordance with the present invention;

FIG. 2 is a plan view illustrating a handle for use in the door lock of the present invention;

FIG. 3 is a front view illustrating the handle for use in the door lock of the present invention;

FIG. 4 is a front view illustrating a handle hub for use in the door lock of the present invention;

FIG. 5 is a sectional view illustrating the handle hub for use in the door lock of the present invention;

FIG. 6 is a sectional view illustrating an assembled state of the handle and handle hub according to the present invention;

FIG. 7 is a front view illustrating a use example of the door lock according to the present invention;

FIG. 8 is a front view illustrating a state wherein movement of the handle is controlled by a stopper after a rivet is removed from the handle hub according to the present invention;

FIG. 9 is a front view illustrating the configuration of a door lock in accordance with the prior art;

FIG. 10 is a sectional view illustrating an assembled state of a handle and a handle hub according to the prior art;

FIG. 11 is a front view illustrating the handle of the prior art;

FIG. 12 is a plan view illustrating the handle of the prior art; and

FIG. 13 is a front view illustrating a state wherein the handle is completely separated from the handle hub after a rivet is removed from the handle hub according to the prior art so as to enable the opening of a cargo container door.

### BEST MODE FOR CARRYING OUT THE INVENTION

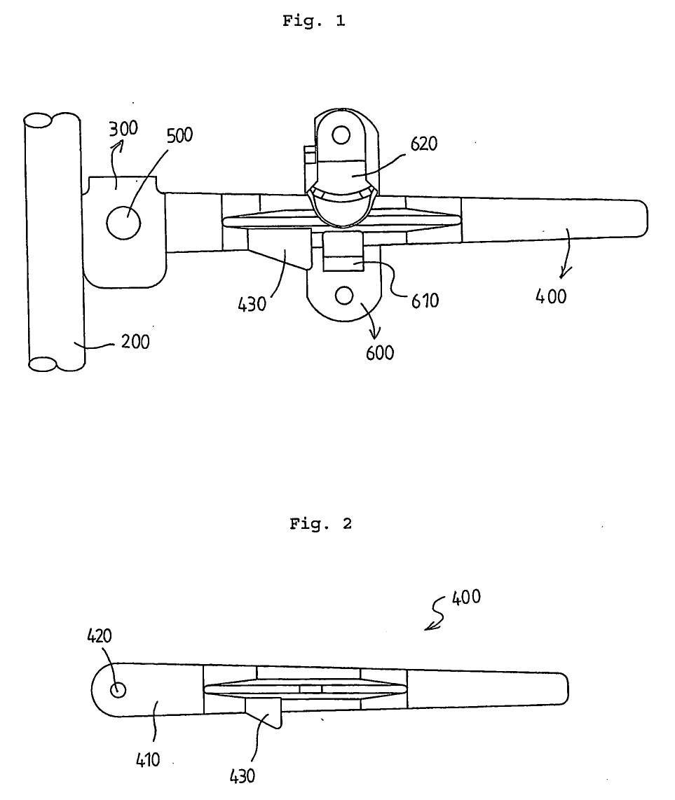

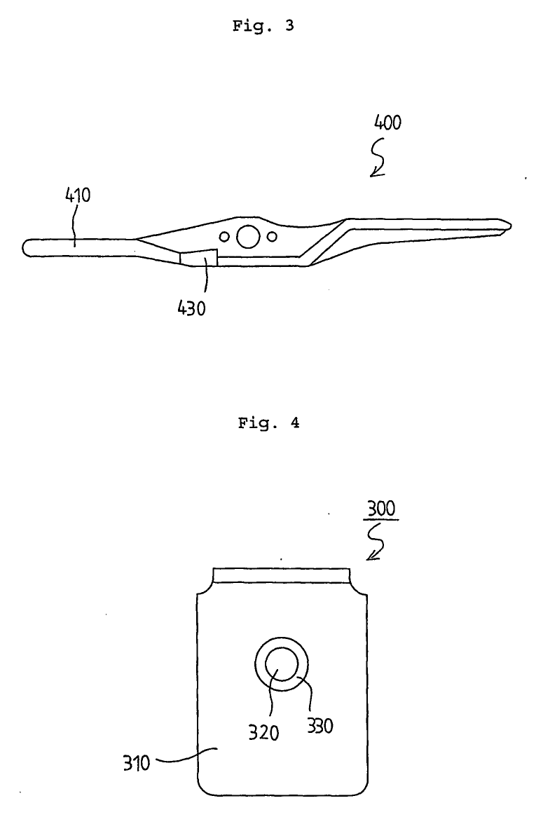

FIG. 1 is a front view illustrating important components of a door lock in accordance with the present invention, and FIGS. 2 to 5 are views illustrating a handle and handle hub for use in the door lock of the present invention.

Considering the installation of the door lock according to the present invention with reference to FIG. 7, the door lock is installed to one side of a locking rod 200, which is installed for opening/closing operations of a door 110 of a cargo container 100.

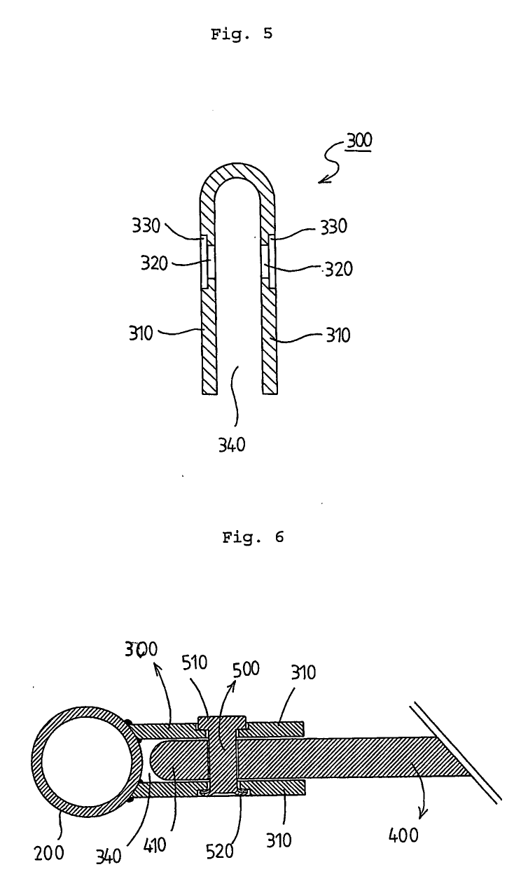

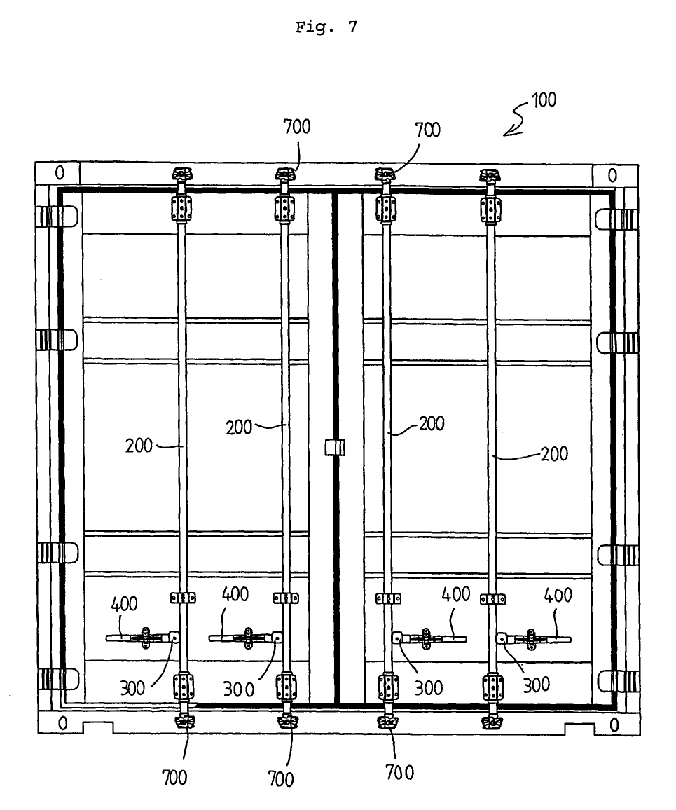

That is, the door lock comprises a handle hub 300 welded to the one side of the locking rod 200. Referring to FIG. 5, the handle hub 300 is formed by bending a steel plate having a constant thickness to have a “U”-shaped cross section. Both leg portions of the U-shaped handle hub 300 form a pair of support pieces 310 arranged in parallel to face each other, and an insertion portion 340 is defined between the support pieces 310.

The support pieces 310 are perforated at the center portions thereof with fastening holes 320, respectively. Additionally, circular recesses 330 having a constant depth are formed at the opposite outer sides of the fastening holes 320, respectively. The circular recesses 330 have a diameter larger than that of the fastening holes 320. Therefore, each of the circular recesses 330 is formed to surround associated one of the fastening holes 320.

Into the insertion portion 340 of the handle hub 300, a handle 400 is inserted therethrough. The handle 400 has a connection portion 410 formed at one end thereof, and the connection portion 410 is drilled with a fastening hole 420. In a state wherein the connection portion 410 of the handle 400 is inserted through the insertion portion 340 of the handle hub 300 so that the fastening hole 420 of the connection portion 410 coincides in parallel with the fastening holes 320 of the handle hub 300, a rivet 500 is fitted through the fastening holes 320 and 420 so that a rivet head 510 thereof is seated in the circular recess 330 associated with the fastening hole 320 of one of the support pieces 310, and an end portion of the rivet 500 at the opposite side to the rivet head 510 is protruded from the fastening hole 320 of the other support piece 320. The protruded end portion of the rivet 500 is compressed according to a rivet joining manner to form an expanded piece 520. The expanded piece 520 is also seated in the circular recess 330 associated with the fastening hole 320 of the other support piece 310 without being protruded outwardly from the other support piece 310.

The handle 400, configured to be coupled with the handle hub 300 using the rivet 500, further has a stopper 430 protruding from the center portion thereof. The handle 400 is retained in place by a fixing plate 600 attached to an outdoor-side surface of the cargo container door 110. That is, the handle 400 is caught by a holding piece 610 and a catch piece 620 formed at the fixing plate 600. The stopper 430 is disposed near one side of the holding piece 610.

Reference numeral 700, not described herein, denotes lockers.

The door lock of the present invention is similar to the conventional door lock in view of the fact that the door 110 of the cargo container 100 is opened and closed using the handle 400.

According to the present invention, however, in a state wherein the handle 400 and the catch piece 620 formed at the fixing plate 600 are fastened together using a strap and then the fastening strap is sealed after the cargo container 100 is loaded with goods to be transported, the door 110 cannot be opened unless the sealed fastening strap is cut and the handle 400 is rotated to be pulled forwardly. Therefore, there is no risk of theft of goods during transit of the cargo container 100, and, even in case of tampering of the door 110 has forcibly occurred, it is possible to promptly identify evidence of tampering, thereby enabling prompt action in response to such a forcible tampering.

Even if a thief tries to cut the head 510 or expanded piece 520 of the rivet 500 fastening the handle hub 300 with the handle 400 using cutting tools, since the head 510 and expanded piece 520 are seated within the circular recesses 330 formed around the fastening holes 320, respectively, the cutting of the head 510 or expanded piece 520 is prevented. Therefore, it is impossible to separate the rivet 500 from the handle hub 300.

Where the thief forcibly cuts the head 510 or expanded piece 520 seated within the circular recess 330, the outer surface of the respective support pieces 310 provided in the handle hub 300 are inevitably cut. Such a cutting of the support pieces 310 is easily confirmed visually. Therefore, the separation of the rivet 500 from the handle hub 300, without inducing obvious evidence of tampering, is essentially impossible.

Even if the rivet 500 is forcibly separated using cutting tools, the connection portion 410 of the handle 400 is adapted not so as to be completely separated from the insertion portion 340 of the handle hub 300. Therefore, the door 110 of the cargo container 100 cannot be opened.

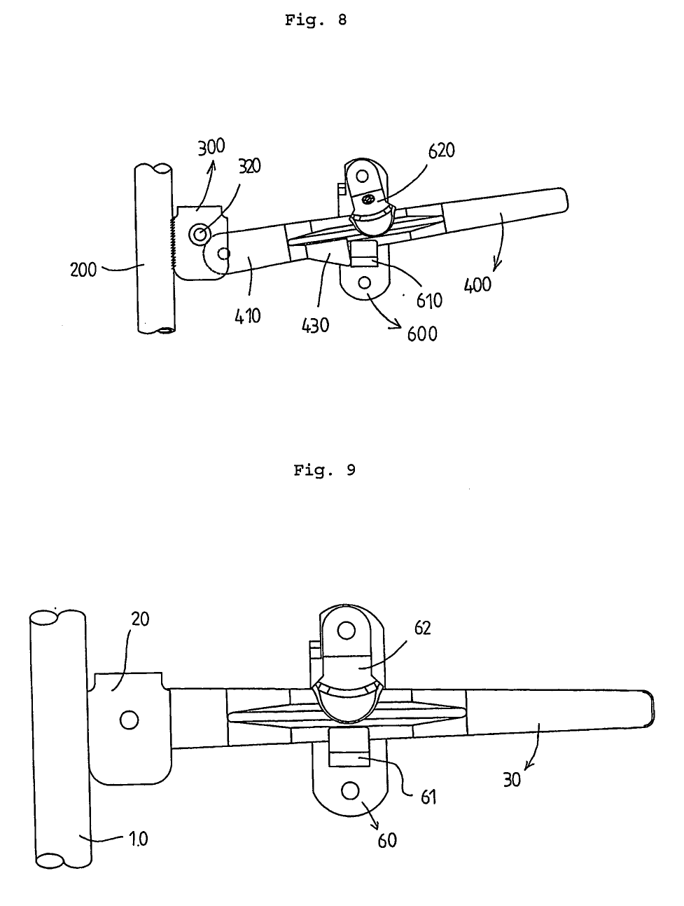

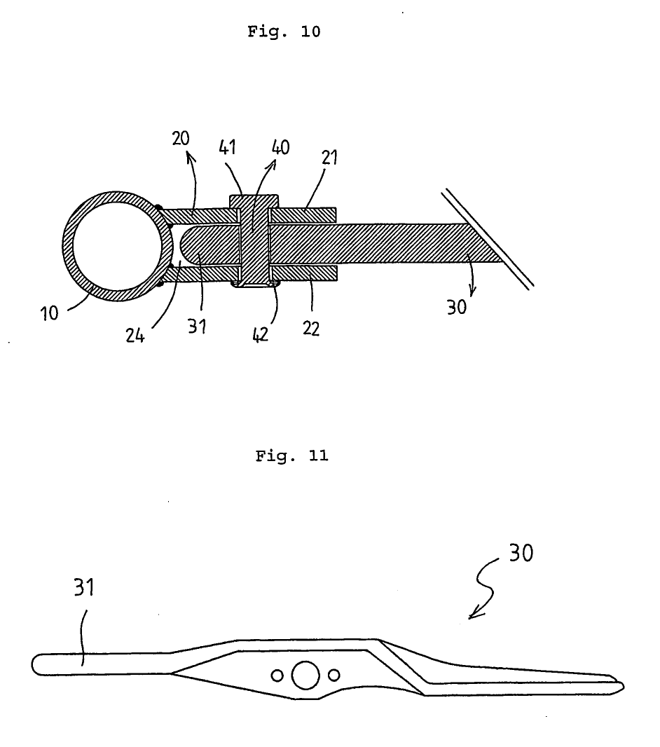

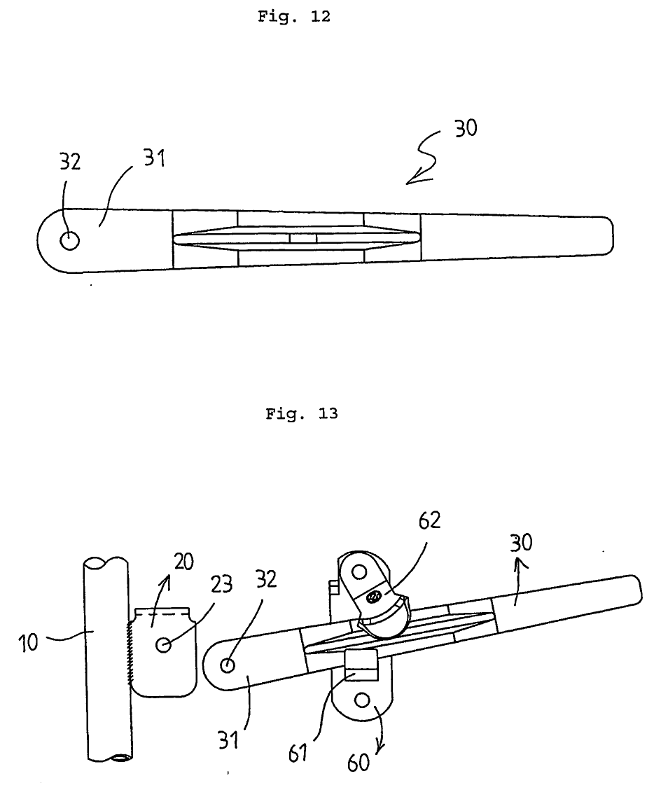

Referring to FIG. 8, where the handle 400 is pushed in an opposite direction to the handle hub 300 in order to be completely separated from the handle hub 300 after the rivet 500 is removed, the protruded stopper 430 of the handle 400 is caught by the holding piece 610 of the fixing plate 600, thereby causing the movement of the handle 400 to be restricted. Therefore, since the connection portion 410 of the handle 400 cannot be completely released from the insertion portion 340 of the handle hub 300, the locking rod 200 cannot be rotated by operating the handle hub 300 as in case of the conventional door lock, resulting in prevention of the opening of the cargo container door.

Since the door lock is configured so that it is substantially difficult to open the cargo container door unless the sealed fastening strap is cut and then the handle is operated, the door lock of the present invention realizes a complete theft prevention function. Further, the door lock provides a clear indication of tampering where the sealed fastening strap is cut, thereby enabling prompt action in response to evidence of tampering.

### INDUSTRIAL APPLICABILITY

As apparent from the above description, the present invention provides a cargo container door lock configured so that a handle hub thereof comprises a pair of fastening holes and a pair of circular recesses formed at opposite outer sides of the fastening holes, respectively, and having a diameter larger than that of the fastening holes, so as to allow a rivet to be fitted therein, thereby preventing the rivet from being unnoticeably cut and removed without leaving clear evidence of tampering. Further, according to the present invention, even if the rivet is forcibly cut, since a handle of the door lock cannot be completely separated from the handle hub due to a stopper protruding from the handle, it is substantially difficult to open a cargo container door. Furthermore, according to the present invention, the cargo container door cannot opened unless a fastening strap sealing the handle is cut and then the handle is operated. Therefore, the door lock of the present invention can effectively protect the contents of a cargo container, and clearly identify when tampering has forcibly occurred, thereby enabling prompt action to be taken based on evidence of tampering.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cargo container door lock with theft prevention means comprising:
a handle hub welded to one side of a locking rod, the handle hub having a pair of fastening holes, and a pair of circular recesses formed at opposite outer sides of the fastening holes, respectively, the circular recesses having a diameter larger than that of the fastening holes; and
a rivet to be fastened through the fastening holes of the handle hub, the rivet having a head to be fitted inside one of the circular recesses, and an expanded piece at opposite side to the head to be fitted inside the other one of the circular recesses.

2. A cargo container door lock with theft prevention means comprising:
a handle hub welded to a locking rod; and
a handle coupled to the handle hub, the handle being formed with a stopper protruding from a center portion thereof, the stopper being positioned near one side of a holding piece provided at a fixing plate associated with the handle.
